(19) United States
(12) Patent Application Publication
(10) Pub. No.: US 2005/0121254 A1
(43) Pub. Date: Jun. 9, 2005

(54) Device for establishing noise in a motor vehicle

(76) Inventors: Marcus Hofmann, Stuttgart (DE); Roudolf Starobinski, Hamburg (DE)

Correspondence Address: KLAUS J. BACH, 4407 TWIN OAKS DRIVE, MURRYSVILLE, PA, 15668, US

(21) Appl. No.: 10/998,360

(22) Filed: Nov. 27, 2004

Related U.S. Application Data
(63) Continuation-in-part of application No. PCT/EP03/03478, filed on Apr. 3, 2003.

(30) Foreign Application Priority Data
May 29, 2002 (DE) 102 23 875.8

(51) Int. Cl. F01N 1/00; F16K 17/00

(52) U.S. Cl. 181/237; 181/236

(57) ABSTRACT

In a device for establishing noise in a motor vehicle including a hollow body which is divided by at least one sound transmission device into at least two spaces, of which one space is in connection, via an inlet line, with a gas-carrying line of an internal combustion engine arranged in the motor vehicle and the other space is acoustically coupled by means of an outlet line to at least one of an interior space of the vehicle or to the space surrounding the vehicle, a valve device is arranged in the inlet line and/or in the outlet line, which is capable of reducing the cross-section of the respective line c\depending on a control variable.

This is a Continuation-In-Part of International Application PCT/EP03/03478 filed Apr. 3, 2003 and claiming the priority of German Application 102 23 875.8 filed May 29, 2002.

### BACKGROUND OF THE INVENTION

The invention relates to a device for establishing noise in a motor vehicle comprising a housing which is divided by a sound transmission device into at least two spaces one of which is in communication with a gas carrying part of an internal combustion engine of the vehicle and the other is acoustically coupled to the interior of the vehicle.

Such a device is known from DE 44 35 296 A1. The purpose of such devices is to transmit the noises produced by the internal combustion engine more intensely to the driver of the motor vehicle, in particular during acceleration, in order, on the one hand, to provide for a more intensive driving experience and, on the other hand, to pass on more information concerning the load state of the engine to the driver.

The disadvantages of this known device, however, are its relatively low efficiency and the very inflexible transmission characteristics thereof.

DE 100 42 012 A1 attempts to improve the efficiency of the overall device. However, an optimum solution is still not offered, in particular since the transmission characteristics are still relatively inflexible.

In various applications it may be desirable to make the noise volume in particular of the transmission dependent on the load state of the engine, which is not possible however with the known devices.

It is therefore the object of the present invention to provide a device for establishing noise in a motor vehicle by means of which the transmission and in particular the volume of the noises produced by the engine in the interior space of the motor vehicle and/or the space adjoining the motor vehicle can be adjusted in certain driving situations.

### SUMMARY OF THE INVENTION

In a device for establishing noise in a motor vehicle including a housing or hollow body which is divided by at least one sound transmission device into at least two spaces, of which one space is in communication via an inlet line with a gas-carrying line of an internal combustion engine arranged in the motor vehicle and the other space is acoustically coupled by means of an outlet line to at least one of an interior space of the vehicle or to the space surrounding the vehicle, a valve device is arranged in the inlet line and/or in the outlet line, which is capable of reducing the cross-section of the respective line in dependence on a control variable.

The valve device provided in according with the invention in the line leading to the housing or extending from it makes it possible to reduce the cross section of the respective line and in this way influence the noise level transmitted by the device according to the invention into the interior space and/or the space surrounding the motor vehicle.

The valve device is in this case subjected to a control variable, various control variables being usable depending on the application or the desired noise transmission by means of the device according to the invention.

In an advantageous embodiment of the invention, the control variable may be a pressure prevailing in the gas-carrying line. In this way, a dependence of the noise transmission on the respective load state of the engine is achieved, which makes it possible particularly advantageously for corresponding information concerning the load state of the engine to be passed on to the driver of the motor vehicle.

In this connection, the gas-carrying line may be an intake line leading to the engine, and a connecting line for tapping the pressure branches off the gas carrying line upstream of a throttle valve arranged in the intake line.

Tapping the intake line upstream of the throttle valve establishes a definite coupling of the transmitted noise to the position of the throttle valve, and consequently in principle to the position of the gas pedal, so that, in particular when driving in a sporty style, a corresponding noise transmission to the driver takes place.

A simple structural design in the case of this embodiment resides in an arrangement wherein the control line extends to the valve device, so that the valve device is directly acted on, and consequently activated by, the pressure in the intake line, which in turn depends primarily on the position of the throttle valve.

The invention will become more readily apparent from the description of exemplary embodiments presented below on the basis of the accompanying drawings:

### BRIEF DESCRIPTION OF THE DRAWINGS

FIG. 1 shows schematically the device for establishing noise in a motor vehicle according to the invention,

FIG. 2 shows the device of FIG. 1 with a valve disposed in the inlet line which valve is in the open position;

FIG. 3 shows the device of FIG. 2 with the valve device in the closed state; and

FIG. 4 is an enlarged view of the valve device of FIG. 3.

### DESCRIPTION OF PREFERRED EMBODIMENTS

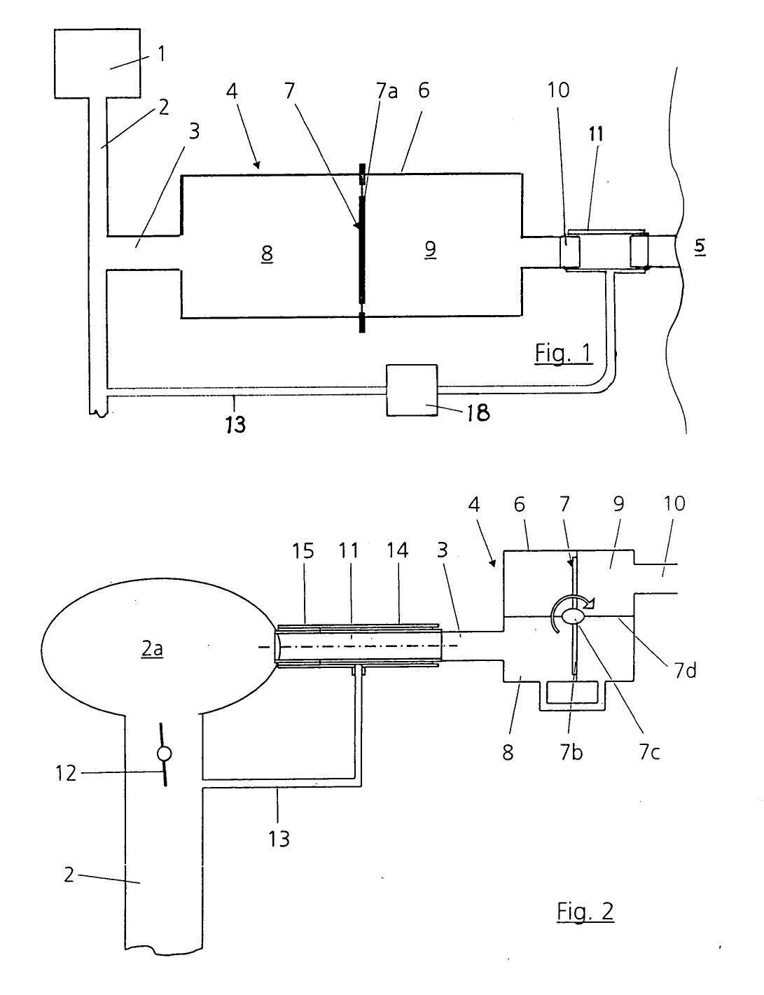

FIG. 1 shows an intake line 2 leading to an internal combustion engine 1, generally a gas-carrying line, which is connected via an inlet line 3 to a device 4 for establishing in the vehicle noises as generated by the engine 1. Instead of branching off from the intake line 2, the inlet line 3 may also branch off from some other gas-carrying line of the engine 1, that is for example from an exhaust line. Like the engine 1, the intake line 2 and the inlet line 3, the device 4 is located in a motor vehicle, which is not represented in its entirety, and is capable of influencing both the noise in an interior space 5 of the motor vehicle and in the surroundings of the same. The basic construction and operating principle of the device 4 are known for example from DE 100 42 012 A1.

The device 4 has a hollow body 6, which is subdivided by a sound transmission device 7, formed in the present case by a vibratable membrane 7a, into two spaces, namely an inlet space 8 and an outlet space 9. The membrane 7a consists of a gas-impermeable material, in order to prevent gas from flowing from the intake line 2 into the outlet line 10.

The inlet space 8 is connected to the inlet line 3, whereas an outlet line 10, which, in the present case, leads to the interior space 5, is connected to the outlet space 9. However, it is also possible to connect the outlet line 10 to a space surrounding the motor vehicle, which is not represented herein. The noises induced in the intake line 2 by pressure surges or pressure differences are introduced via the inlet line 3 into the inlet space 8 of the hollow body 6, whereby the sound transmission device 7 is acted on and induced to vibrate. When acted on in this way, the sound transmission device 7 vibrates with a natural frequency that is typical of it, which is passed on by the air located in the outlet space 9 to the outlet line 10.

In the present case, a valve device 11 is disposed in the outlet line 10 for reducing the cross section of the outlet line 10. In this way, the noise that is produced by the sound transmission device 4 and transported further by the outlet line 10 can be controlled such that, the transmitted volume is reduced by a reduction in the cross section of the outlet line 10. The valve device 11 is controlled in dependence on a control variable, which is discussed in more detail below.

In the embodiment of the device 4 according to FIG. 2, the valve device 11 is arranged in the inlet line 3 branching off from a collecting tank 2a which is known per se and adjoins the intake line 2, and is consequently capable of reducing the cross section of the inlet line 3. In principle, a valve device 11 may be located in the inlet line 3 and/or the outlet line 10. Upstream of a throttle valve 12 arranged in the inlet line 2 there branches off a control line 13, which extends to a housing 14 of the valve device 11. In the state represented, the throttle valve 12 is open, which is the case whenever the driver accelerates and the engine 1 is operated with full load or at least with a high load. With the throttle valve 12 open the same pressure prevails in the control line 13 as in the intake line 2, the inlet line 3, the valve device 11 and the inlet space 8, so that there are no pressure differences and accordingly the cross section of the inlet line 3 is not reduced, so that the noises present in the intake line 2 can reach the sound transmission device 7 un-throttled. This is appropriate or desired in the open state of the throttle valve 12, since it is specifically in the loaded state of the engine 1 that the driver wishes to be supplied with the previously described acoustic information from the engine 1.

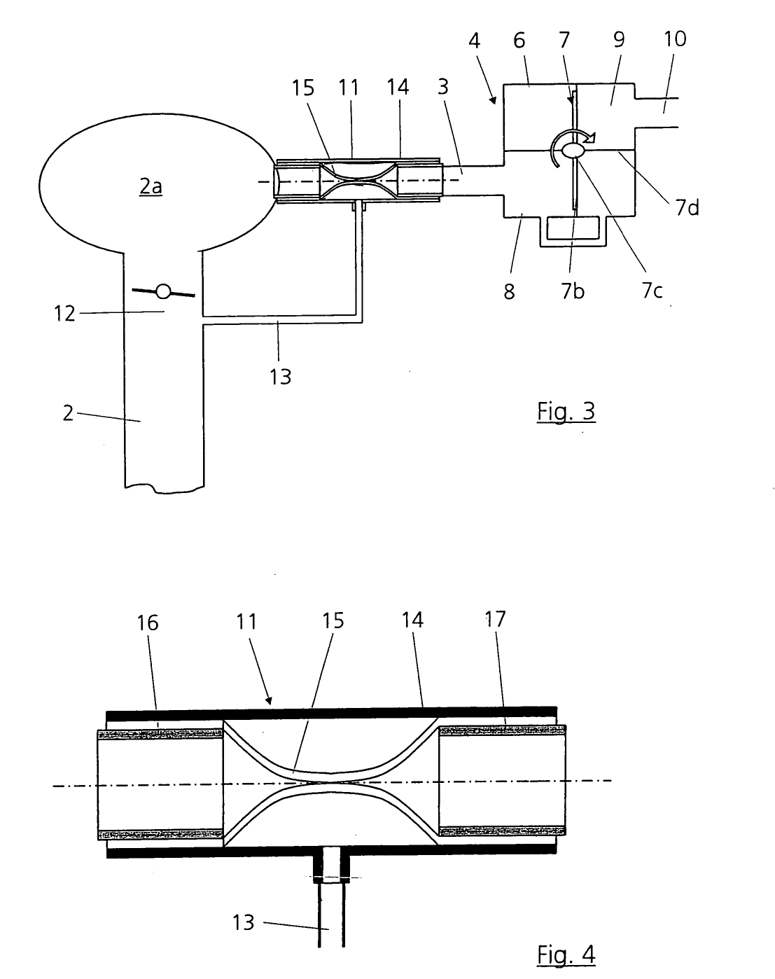

If, however, the throttle valve 12 is in the closed state, as is shown in FIG. 3, the pressure in the control line 13 branching off upstream of the throttle valve 12 is higher than in the intake line 2, the inlet line 3 and the valve device 11. In this position of the throttle valve 12, the way in which the valve device 11 is acted on by the control line 13 leads to the closing of the valve device 11, and consequently to reduction of the cross section of the inlet line 3, as illustrated below. As a result, in the closed state of the valve device 11, the noises produced in the intake line 2 are no longer passed on into the inlet space 8, and consequently to the sound transmission device 7, or only at a greatly throttled level, whereby, in a low-load state of the engine 1, the driver of the motor vehicle only receives a low-level acoustic feedback, or none at all, from the engine 1.

Both in FIG. 2 and in FIG. 3, the sound transmission device 7 is not formed by a membrane 7a but by a vibratable element 7b, which can vibrate about a pivot point 7c, and consequently directs the sound waves from the inlet space 8 into the outlet space 9. The pivot point 7c is located on an acoustically inactive wall 7d, which separates the inlet space 8 from the outlet space 9 and consequently, like the membrane 7a described above, prevents a flow of gas from the intake line 2 to the outlet line 10.

FIG. 4 shows the actual configuration of the valve device 11, which has a flexible hose line 15, which is arranged in the housing 14 and the clear width of which, as represented, is reduced when it is subjected to pressure via the control line 13, possibly to the extent that the passage through the inlet line 3 is completely blocked. This can be influenced by the choice of the material of the hose line 15, which may for example consist of silicone. In order to retain the flexible hose line 15 in the housing 14, the hose line is clamped between the housing 14 and two pieces of pipe 16 and 17, which are arranged in the housing 14 and are axially spaced apart from each other.

In an embodiment as indicated in FIG. 1, the control line 13 is connected to a pressure measuring and control device 18 or the like, which senses the pressure and controls opening and closing of the valve device 11, depending on the pressure in the control line 13. In all cases the valve device can be formed both as an open-close valve and as a rate-controllable valve.

Furthermore, other control variables could also be used for the opening and closing of the valve device 11, for example a pressure prevailing in the exhaust line or else a variable to be determined by the driver of the motor vehicle. It is also conceivable to provide adaptive control for the valve device 11, so that the noise produced by the device 4 and directed into the interior space 5 or the space surrounding the motor vehicle is controllable, for example, depending on the driving style of the driver.

1. A device for establishing noise in a motor vehicle including an internal combustion engine (1) and comprising a housing (4), which is divided by at least one sound transmission device (7) into at least two spaces (8, 9), one space (8) being in connection via an inlet line (3) with a gas-carrying line (2) of the internal combustion engine (1) and the other space being acoustically coupled by means of an outlet line (10) to at least one of an interior space (5) of the vehicle and a space surrounding the vehicle, at least one of said inlet line (3) and said outlet line (10) including a valve device (11), which is capable of reducing the cross section of the respective line (3, 10) depending on a control variable.

2. The device as claimed in claim 1, wherein the valve device (11) is capable of completely closing the respective line (3, 10).

3. The device as claimed in claim 1, wherein the control variable is a pressure prevailing in the gas-carrying line (2).

4. The device as claimed in claim 3, wherein the gas-carrying line (2) is an intake line leading to the engine (1), and a control line (13) for tapping the pressure branches off the intake line (2), in the direction of flow, upstream of a throttle valve (12) arranged in the intake line (2).

5. The device as claimed in claim 4, wherein the control line (13) is connected to the valve device (11).

6. The device as claimed in claim 5, wherein the control line (13) is connected to a housing (14) of the valve device (11), the valve device (11) including a flexible hose line (15), having a flow cross-section, which is reduced when it is subjected to pressure via the control line (13).

7. The device as claimed in claim 6, wherein the flexible hose line (15) is clamped between the housing (14) and two pieces of pipe (16, 17), which are arranged inside the housing (14).

8. The device as claimed in claim 4, wherein the pressure prevailing in the control line (13) is measured by means of a measuring device and passed on to a control device (18), which is provided for controlling the valve device (11).
